(19) United States
(12) Patent Application Publication
(10) Pub. No.: US 2026/0184977 A1
(43) Pub. Date: Jul. 2, 2026

(54) ADHESIVE COMPOSITION AND POUCH FILM

(71) Applicant: YOULCHON CHEMICAL CO., LTD., Seoul (KR)

(72) Inventors: Nok Jung SONG, Seoul (KR); Hee Sik HAN, Gyeonggi-do (KR); Ji Min LEE, Gyeonggi-do (KR); Han Chul PARK, Gyeonggi-do (KR)

(21) Appl. No.: 19/423,972

(22) Filed: Dec. 17, 2025

(30) Foreign Application Priority Data
Dec. 30, 2024 (KR) 10-2024-0200646

(51) Int. Cl. C09J 175/06; B32B 7/12; B32B 15/088; B32B 15/20; B32B 27/08; B32B 27/32; B32B 27/34; B32B 27/36; B65D 75/26; C09J 11/06; C09J 11/08

(52) U.S. Cl. CPC C09J 175/06; B32B 7/12; B32B 15/088; B32B 15/20; B32B 27/08; B32B 27/32; B32B 27/34; B32B 27/36; B65D 75/26; C09J 11/06; C09J 11/08; B32B 2250/05; B32B 2307/7244; B32B 2307/7265; B32B 2307/7376; B32B 2311/24; B32B 2439/46

(57) ABSTRACT

Provided are a pouch film and an adhesive composition are provided. The adhesive composition includes a main agent, a curing agent, a plasticizer, and a reaction retarder within specific content ranges, and may maintain high production efficiency and minimize generation of bubbles during a curing reaction to improve product quality, and may ensure an excellent adhesive strength even under high-temperature and high-humidity conditions.

### CROSS-REFERENCE TO RELATED APPLICATION

This application claims the benefit of priority to Korean Patent Application No. 10-2024-0200646, filed in the Korean Intellectual Property Office on Dec. 30, 2024, the entire contents of which are incorporated herein by reference.

### TECHNICAL FIELD

The present disclosure relates to a pouch film and an adhesive composition.

### BACKGROUND

Secondary batteries are energy storage devices that may be repeatedly charged and discharged, and are widely used in various electronic devices, electric vehicles, and energy storage systems, and may be classified into a cylindrical secondary battery, a prismatic secondary battery, and a pouch-type secondary battery according to structures and manufacturing methods.

Among the secondary batteries, a pouch-type secondary battery has a form, in which an electrode assembly (cell) is embedded in a pouch of a metal-laminate sheet, and it is easy to manufacture and has a low manufacturing cost, and, in particular, because a plurality of unit cells may be easily connected in series or in parallel to manufacture a large-capacity battery pack, it is mainly utilized in fields, in which a large-capacity secondary battery is required, such as an electric vehicle. A pouch that is a case of the pouch-type secondary battery is manufactured by pressing a pouch-film laminate having flexibility. Furthermore, when the cup part is formed, a secondary battery is manufactured by accommodating an electrode assembly in an accommodation space of the cup part and sealing a sealing part. In this way, a battery body part sealed by the pouch film substantially may not be exposed to an external environment.

In general, the secondary-battery pouch film may have a structure, in which a sealant layer, a barrier layer, and an outer layer are sequentially laminated, and may further include an adhesive layer that adheres the respective layers. The respective layers are designed to have optimum structural characteristics, and, in particular, an adhesive layer is laminated between the barrier layer and the outer layer to greatly improve an overall performance of the pouch film. Specifically, a performance of an adhesive used for the adhesive layer has an important influence on an overall performance of the pouch film. Accordingly, development of an adhesive composition for a secondary-battery pouch serves as a key factor in improving performances of secondary-battery pouch films.

Conventional adhesive compositions for secondary-battery pouches have been manufactured based on various polyols and curing agents, but there has been room for improvement in adhesion strength, durability, and flexibility.

Meanwhile, secondary-battery pouches are often required to be operated in high-temperature and high-humidity environments, and under such conditions, physical and chemical properties of the adhesive may change significantly. Specifically, under high-temperature conditions, a curing rate of the adhesive may become faster or mechanical strength may be degraded, and under high-humidity conditions, moisture may penetrate into an interior of the adhesive layer, which may cause problems such as a decrease in adhesive strength and interlayer delamination. In addition, bubbles may be generated on a surface of the barrier layer during a coating process using a curing agent, and this becomes a major cause of deteriorating product quality. However, when a curing time becomes excessively long, bubble generation may be reduced, but problems may occur in production efficiency, and therefore, it is important to adjust a balance between the curing time and suppression of bubble generation. Accordingly, there has been a need for an adhesive for secondary-battery pouches that can suppress bubble generation during a curing reaction in consideration of production efficiency and may stably maintain its performance even under extreme environments.

### SUMMARY

The present disclosure has been made to solve the above-mentioned problems occurring in the prior art while advantages achieved by the prior art are maintained intact.

An aspect of the present disclosure provides a pouch film and an adhesive composition, by which a high production efficiency may be maintained, a quality of a product may be improved by minimizing generation of bubbles during a curing reaction, and an excellent adhesive strength may be ensured even under high-temperature and high-humidity conditions.

The technical problems to be solved by the present disclosure are not limited to the aforementioned problems, and any other technical problems not mentioned herein will be clearly understood from the following description by those skilled in the art to which the present disclosure pertains.

The present disclosure provides a pouch film and an adhesive composition.
(1) The present disclosure provides a pouch film including an outer layer, an adhesive layer, a barrier layer, and a sealant layer, wherein the adhesive layer includes an adhesive composition including a main agent, a curing agent, a plasticizer, and a reaction retarder, and, based on 100 parts by weight of the main agent, the plasticizer is included in an amount of 0.1 parts by weight or more and 1.4 parts by weight or less, and the reaction retarder is included in an amount of 0.1 parts by weight or more and 2.0 parts by weight or less.
(2) in (1), based on 100 parts by weight of the main agent, the curing agent is included in an amount of 5 parts by weight or more and 15 parts by weight or less, and a solvent is included in an amount of 50 parts by weight or more and 80 parts by weight or less.
(3) in (1) or (2), based on 100 parts by weight of the main agent, the plasticizer is included in an amount of 0.3 parts by weight or more and 1.0 parts by weight or less, and the reaction retarder is included in an amount of 0.7 parts by weight or more and 1.5 parts by weight or less.
(4) in any one of (1) to (3), the main agent includes a polyester polyol, and the polyester polyol includes one or more compounds selected from the group consisting of a polyester polyol of 1,4-butanediol and adipic acid, a polycarbonate diol, and a polyurethane polyol.
(5) in any one of (1) to (4), the curing agent includes one or more compounds selected from the group consisting of aliphatic isocyanate and aromatic isocyanate.
(6) in any one of (1) to (5), the curing agent includes one or more compounds selected from the group consisting of hexamethylene diisocyanate, isophorone diisocyanate, methylene diphenyl diisocyanate, toluene diisocyanate, and xylene diisocyanate.
(7) in any one of (1) to (6), the plasticizer includes one or more compounds selected from the group consisting of polycaprolactone, dioctyl phthalate, dioctyl adipate, acetyl tributyl citrate, and polycarbonate diol.
(8) in any one of (1) to (7), the reaction retarder includes one or more compounds selected from the group consisting of phenyl carbamate, butyl carbamate, 2,2′-dimorpholinodiethyl ether, triethylenediamine, triphenyl phosphite, and tris(2-chloroethyl) phosphite.
(9) in any one of (1) to (8), the outer layer includes a first outer layer and a second outer layer laminated between the first outer layer and the barrier layer, and the adhesive layer is disposed at one or more positions selected from the group consisting of between the second outer layer and the barrier layer and between the first outer layer and the second outer layer.
(10) in any one of (1) to (9), an average thickness of the adhesive layer is 3 μm or more and 5 μm or less.
(11) in any one of (1) to (10), an average thickness of the pouch film is 150 μm or more and 250 μm or less.
(12) in any one of (1) to (11), the first outer layer includes one or more materials selected from the group consisting of polyethylene, polypropylene, polycarbonate, polyethylene terephthalate, polybutylene terephthalate, polytrimethylene terephthalate, polyethylene naphthalate, polyvinyl chloride, acrylic polymer, polyacrylonitrile, polyimide, polyamide, cellulose, aramid, nylon, polyester, poly-p-phenylene benzobisoxazole, polyarylate, Teflon, and glass fiber.
(13) in any one of (1) to (12), the second outer layer includes one or more compounds selected from the group consisting of polyamide-based compound, polyester-based compound, polyolefin-based compound, and polyacrylic-based compound.
(14) in any one of (1) to (13), a ratio of a thickness of the barrier layer to a thickness of the adhesive layer is 12 to 27:1.
(15) The present disclosure provides an adhesive composition including a polyester polyol, and based on 100 parts by weight of the polyester polyol, the composition includes 5 to 15 parts by weight of a curing agent, 0.1 to 1.4 parts by weight of a plasticizer, and 0.1 to 2.0 parts by weight of a reaction retarder.

### BRIEF DESCRIPTION OF THE DRAWINGS

The above and other objects, features and advantages of the present disclosure will be more apparent from the following detailed description taken in conjunction with the accompanying drawings:

FIG. 1 is a schematic view illustrating a configuration of a secondary battery pouch film having an adhesive layer between a second outer layer and a barrier layer; and

FIG. 2 is a schematic view illustrating a configuration of a secondary battery pouch film having an adhesive layer between a first outer layer and a second outer layer and between the second outer layer and a barrier layer.

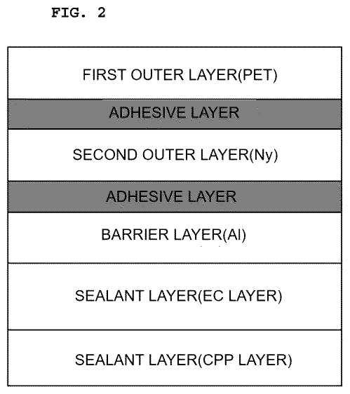

### DETAILED DESCRIPTION

Hereinafter, the present disclosure will be described in more detail to help understanding of the present disclosure.

Terms or words used in the specification and claims should not be interpreted as being limited to ordinary or dictionary meanings, and should be interpreted as meanings and concepts that are consistent with the technical idea of this present disclosure based on the principle that the inventor may properly define the concepts of the terms to explain his or her invention in the best way.

The terms used herein are for the purpose of describing exemplary embodiments only, and are not intended to limit the present disclosure. Singular forms include plural forms unless interpreted otherwise in context.

It will be further understood that the terms “comprises,” “comprising,” “includes,” and/or “including,” when used herein, specify the presence of stated features, numbers, steps, components, or combinations thereof, but do not preclude the presence or addition of one or more other features, numbers, steps, components, or combinations thereof.

### Secondary Battery Pouch Film

The present disclosure provides a pouch film including an outer layer, an adhesive layer, a barrier layer, and a sealant layer, wherein the adhesive layer includes an adhesive composition including a main agent, a curing agent, a plasticizer, and a reaction retarder, and, based on 100 parts by weight of the main agent, the plasticizer is included in an amount of 0.1 parts by weight or more and 1.4 parts by weight or less, and the reaction retarder is included in an amount of 0.1 parts by weight or more and 2.0 parts by weight or less.

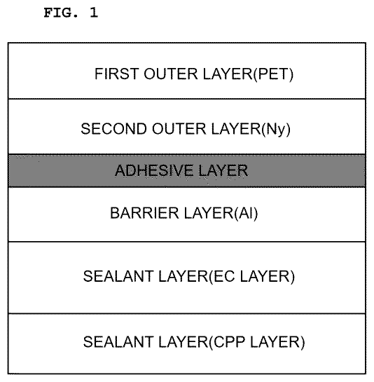

FIG. 1 is a schematic view illustrating a configuration of a secondary battery pouch film having an adhesive layer between a second outer layer and a barrier layer. The secondary battery pouch film of the present disclosure includes an inner sealant layer, an outer layer, a barrier layer including aluminum between the inner sealant layer and the outer layer, and an adhesive layer. In this case, the outer layer includes a first outer layer and a second outer layer, and the adhesive layer includes an adhesive layer that is laminated between the barrier layer and the second outer layer.

The adhesive layer serves to firmly couple respective layers in the secondary battery pouch film including multiple layers and to maintain stability and performance of the overall structure. Specifically, the adhesive layer firmly couples the outer layer, the barrier layer, and the sealant layer to prevent delamination between layers, and increases a mechanical strength of the secondary battery pouch film to enhance resistance to external impact or deformation. Furthermore, it may help the secondary battery pouch film maintain a desired shape without cracks or deformation during a forming process, and may maintain long-term stability. As such, the adhesive layer may protect the secondary battery pouch film from external environmental factors, such as moisture, heat, and gas, to increase reliability of the overall structure, and may maintain an adhesive strength over time so that a lifespan and performance of the battery may be ensured.

According to an embodiment of the present disclosure, the outer layer includes a first outer layer and a second outer layer that is laminated between the first outer layer and the barrier layer, and an adhesive layer may be further included between the first outer layer and the second outer layer.

The adhesive layer may be formed via an adhesive applying operation and a curing operation. In the adhesive applying operation, an adhesive composition for the secondary battery pouch of the present disclosure may be applied to respective layers corresponding to adherends by various methods, such as spray, roll coating, brush application, dipping, or laminate printing. In the curing operation, the secondary battery pouch film that has undergone the applying process may be cured by any one of room-temperature curing, heat curing, light curing, moisture curing, or chemical curing, and preferably, by chemical curing. The curing operation may be performed for 24 to 140 hours, preferably, for 48 to 120 hours. However, in the curing reaction process, bubbles and defects (foreign substances) may occur in the film depending on a curing rate, so that completeness and quality of the product may be degraded. The curing rate may be adjusted by the curing agent included in the adhesive composition, and production efficiency and a degree of bubble formation suppression may be controlled depending on the curing rate.

Hereinafter, the adhesive composition included in the adhesive layer will be described.

The adhesive layer composition includes a main agent, a curing agent, a plasticizer, and a reaction retarder, and, based on 100 parts by weight of the main agent, the plasticizer is included in an amount of 0.1 parts by weight or more and 1.4 parts by weight or less, and the reaction retarder is included in an amount of 0.1 parts by weight or more and 2.0 parts by weight or less.

The plasticizer serves to dilute the curing agent included in the adhesive composition, to control a rate of the curing reaction, and to improve heat resistance and mechanical properties. Particularly, the plasticizer may increase a flexibility of the cured film in an isocyanate curing reaction, may be easy to use for controlling an initial viscosity, and may improve film processability.

The plasticizer may include one or more compounds selected from the group consisting of polycaprolactone, dioctyl phthalate, dioctyl adipate, acetyl tributyl citrate, and polycarbonate diol.

The plasticizer is included in an amount of 0.1 parts by weight or more and 1.4 parts by weight or less, based on 100 parts by weight of the main agent. By way of example, the plasticizer may be included in an amount of 0.10 parts by weight or more, 0.15 parts by weight or more, 0.20 parts by weight or more, 0.25 parts by weight or more, 0.30 parts by weight or more, 0.35 parts by weight or more, 0.36 parts by weight or more, 0.40 parts by weight or more, 0.45 parts by weight or more, 0.50 parts by weight or more, 0.55 parts by weight or more, 0.60 parts by weight or more, 0.65 parts by weight or more, 0.70 parts by weight or more, and may be 1.40 parts by weight or less, 1.35 parts by weight or less, 1.30 parts by weight or less, 1.25 parts by weight or less, 1.20 parts by weight or less, 1.15 parts by weight or less, 1.10 parts by weight or less, 1.05 parts by weight or less, 1.00 parts by weight or less, 0.95 parts by weight or less, 0.91 parts by weight or less, or 0.90 parts by weight or less, and more specifically, the plasticizer may be included in an amount of 0.3 parts by weight or more and 1.0 parts by weight or less. When a content of the plasticizer deviates from a lower limit of the above range, coating uniformity, heat resistance, and flexibility may be degraded. Furthermore, when a content of the plasticizer deviates from an upper limit of the above range, mechanical properties, such as delamination strength and tensile strength, may be degraded.

The reaction retarder serves to control a rate of the curing reaction by the curing agent included in the adhesive composition and to prevent generation of bubbles or defects (foreign substances) generated during the curing reaction.

The reaction retarder may include one or more compounds selected from the group consisting of phenyl carbamate, butyl carbamate, 2,2′-dimorpholinodiethyl ether, triethylenediamine, triphenyl phosphite, and tris(2-chloroethyl) phosphite.

The reaction retarder is included in an amount of 0.1 parts by weight or more and 2.0 parts by weight or less, based on 100 parts by weight of the main agent. By way of example, the reaction retarder may be included in an amount of 0.10 parts by weight or more, 0.15 parts by weight or more, 0.20 parts by weight or more, 0.25 parts by weight or more, 0.30 parts by weight or more, 0.35 parts by weight or more, 0.40 parts by weight or more, 0.45 parts by weight or more, 0.50 parts by weight or more, 0.55 parts by weight or more, 0.60 parts by weight or more, 0.65 parts by weight or more, 0.70 parts by weight or more, 0.73 parts by weight or more, or 0.75 parts by weight or more, and may be 2.00 parts by weight or less, 1.95 parts by weight or less, 1.90 parts by weight or less, 1.85 parts by weight or less, 1.80 parts by weight or less, 1.75 parts by weight or less, 1.70 parts by weight or less, 1.65 parts by weight or less, 1.60 parts by weight or less, 1.55 parts by weight or less, 1.50 parts by weight or less, 1.45 parts by weight or less, 1.40 parts by weight or less, 1.35 parts by weight or less, 1.30 parts by weight or less, 1.25 parts by weight or less, 1.20 parts by weight or less, 1.15 parts by weight or less, or 1.10 parts by weight or less, and specifically, the reaction retarder may be included in an amount of 0.7 parts by weight or more and 1.5 parts by weight or less. When the content of the reaction retarder deviates from a lower limit of the above range, it may be difficult to suppress generation of bubbles and defects by the curing reaction. Furthermore, when the content of the reaction retarder deviates from an upper limit of the above range, delamination strength and long-term reliability may be degraded.

That is, the plasticizer and the reaction retarder correspond to important factors for controlling a rate of the curing reaction of the adhesive composition, and it is preferable that contents of the plasticizer and the reaction retarder satisfy both of the above ranges. By satisfying both contents of the plasticizer and the reaction retarder, bubbles that may occur during curing may be minimized to reduce surface defects, a curing rate may be controlled so that physical properties of the product may be maintained constant, and heat resistance and flexibility of a final product may be improved. Additionally, stable physical properties may be provided even at high temperatures after curing to enhance durability of the product.

According to an embodiment of the present disclosure, the main agent includes a polyester polyol, and the polyester polyol may include one or more compounds selected from the group consisting of a polyester polyol of 1,4-butanediol and adipic acid, a polycarbonate diol, and a polyurethane polyol. The polyester polyol may be formed by a condensation reaction of a polyalcohol and a polyacid.

The polyester polyol serves as a basic component of the adhesive composition and provides excellent adhesive strength to various materials. This results in firmly adhering various layers of the secondary battery pouch film. Additionally, the polyester polyol serves to allow the adhesive to withstand physical impact or deformation to improve mechanical strength and durability of the adhesive, and provides flexibility to the adhesive composition to absorb stress generated during expansion and contraction of the battery and to help prevent the adhesive layer from being damaged.

Additionally, a number average molecular weight of the polyester polyol may be 3,000 g/mol or more and 50,000 g/mol or less, and more specifically, a number average molecular weight of the main agent may be 3,000 g/mol or more, 3,200 g/mol or more, 3,500 g/mol or more, 3,700 g/mol or more, 4,000 g/mol or more, 4,500 g/mol or more, 5,000 g/mol or more, 5,500 g/mol or more, 6,000 g/mol or more, 6,500 g/mol or more, 7,000 g/mol or more, 7,500 g/mol or more, 8,000 g/mol or more, 8,500 g/mol or more, 9,000 g/mol or more, 10,000 g/mol or more, 11,000 g/mol or more, 12,000 g/mol or more, 13,000 g/mol or more, 14,000 g/mol or more, 15,000 g/mol or more, 16,000 g/mol or more, 17,000 g/mol or more, 18,000 g/mol or more, 19,000 g/mol or more, 20,000 g/mol or more, 21,000 g/mol or more, 22,000 g/mol or more, 23,000 g/mol or more, 24,000 g/mol or more, 25,000 g/mol or more, 26,000 g/mol or more, 27,000 g/mol or more, 28,000 g/mol or more, 29,000 g/mol or more, or 30,000 g/mol or more, and 50,000 g/mol or less, 49,000 g/mol or less, 48,000 g/mol or less, 47,000 g/mol or less, 46,000 g/mol or less, 45,000 g/mol or less, 44,000 g/mol or less, 43,000 g/mol or less, 42,000 g/mol or less, 41,000 g/mol or less, 40,000 g/mol or less, 39,000 g/mol or less, 38,000 g/mol or less, 37,000 g/mol or less, 36,000 g/mol or less, 35,000 g/mol or less, 34,000 g/mol or less, 33,000 g/mol or less, or 32,000 g/mol or less. A number average molecular weight of the polyester polyol affects physical properties of the adhesive composition, such as strength, flexibility, and adhesive strength, and an appropriate range of the number average molecular weight increases viscoelasticity and durability of the adhesive composition, so that an adhesive layer of the secondary battery pouch film may maintain adhesion performance for a long period of time without physical damage even under high-temperature and high-humidity conditions.

The main agent may be included in an amount of 100 parts by weight based on the main agent, and when the main agent is included in the adhesive composition in the above amount, mechanical strength, durability, and adhesive strength of the adhesive may be improved, and, when mixed with the curing agent, generation of bubbles during a curing process may be suppressed.

According to an embodiment of the present disclosure, the curing agent may include one or more compounds selected from the group consisting of an aliphatic isocyanate and an aromatic isocyanate, and more specifically, the curing agent may include one or more compounds selected from the group consisting of hexamethylene diisocyanate, isophorone diisocyanate, methylene diphenyl diisocyanate, toluene diisocyanate, and xylene diisocyanate. The curing agent serves to cure the adhesive composition, and accordingly, the adhesive composition is converted into a solid state and an adhesive layer having final physical properties is formed. The hexamethylene diisocyanate, isophorone diisocyanate, and xylene diisocyanate correspond to aliphatic isocyanates, and the aliphatic isocyanates have excellent chemical resistance and heat resistance, structurally have flexibility, do not cause yellowing, and generate a small amount of carbon dioxide as a side reaction during a curing reaction. Furthermore, the methylene diphenyl diisocyanate and the toluene diisocyanate correspond to aromatic isocyanates, and a curing rate may proceed considerably fast so that production efficiency may be increased.

The curing agent is included in an amount of 5.0 parts by weight or more and 15.0 parts by weight or less, based on 100 parts by weight of the main agent. By way of example, the curing agent may be included in an amount of 5.0 parts by weight or more, 5.5 parts by weight or more, 6.0 parts by weight or more, 6.5 parts by weight or more, 7.0 parts by weight or more, 7.5 parts by weight or more, 7.6 parts by weight or more, 8.0 parts by weight or more, 8.5 parts by weight or more, 9.0 parts by weight or more, 9.5 parts by weight or more, or 10.0 parts by weight or more, and may be 15.0 parts by weight or less, 14.5 parts by weight or less, 14.0 parts by weight or less, 13.5 parts by weight or less, 13.0 parts by weight or less, 12.8 parts by weight or less, 12.5 parts by weight or less, or 12.0 parts by weight or less, and when the curing agent satisfies the above range, a proper curing rate may be maintained to maximize production efficiency, flexibility of the adhesive composition may be secured, and generation of bubbles during the curing reaction may be suppressed to improve completeness of the product.

The solvent enables uniform application of the adhesive composition and helps the curing agent and the main agent to be well mixed by controlling the curing rate. Furthermore, it serves to improve quality of the adhesive composition by preventing bubbles or surface defects.

According to an embodiment of the present disclosure, the solvent may include one or more compounds selected from the group consisting of acetone, methyl ethyl ketone, toluene, ethyl acetate, hexane, isopropyl alcohol, dichloromethane, and chloroform, and the solvent may be included in an amount of 50 parts by weight or more, 52 parts by weight or more, 54 parts by weight or more, 56 parts by weight or more, 58 parts by weight or more, 60 parts by weight or more, 62 parts by weight or more, 64 parts by weight or more, or 66 parts by weight or more, and 80 parts by weight or less, 78 parts by weight or less, 76 parts by weight or less, 74 parts by weight or less, 72 parts by weight or less, 70 parts by weight or less, or 68 parts by weight or less. When the solvent satisfies the above range, the main agent and the curing agent may be smoothly mixed.

A combination of the main agent, the curing agent, the plasticizer, and the reaction retarder plays an important role in optimizing performance of the adhesive composition of the present disclosure. For example, a combination of the main agent and the curing agent provides balanced physical properties of the adhesive composition, and limiting ranges of parts by weight of the plasticizer and the reaction retarder may simultaneously improve mechanical strength and flexibility of the adhesive, and may suppress the number of bubbles and defects that may occur on a surface of the barrier layer by controlling the curing reaction. A combination of respective components significantly improves adhesive strength, durability, impact resistance, and stability of the adhesive under high-temperature and high-humidity conditions. This allows the adhesive composition of the present disclosure to exhibit high performance in various applications.

According to an embodiment of the present disclosure, an average thickness of the adhesive layer may be 3 μm or more and 5 μm or less. By way of example, an average thickness of the adhesive layer may be 3.0 μm or more, 3.1 μm or more, 3.2 μm or more, 3.3 μm or more, 3.4 μm or more, 3.5 μm or more, 3.6 μm or more, 3.7 μm or more, 3.8 μm or more, or 3.9 μm or more, and may be 5.0 μm or less, 4.9 μm or less, 4.8 μm or less, 4.7 μm or less, 4.6 μm or less, 4.5 μm or less, 4.4 μm or less, 4.3 μm or less, 4.2 μm or less, 4.1 μm or less, or 4.0 μm or less. When a thickness of the adhesive layer satisfies the above range, an interlayer adhesion strength may be optimized to prevent delamination, and a mechanical strength of the secondary battery pouch film may be increased to increase resistance to external impact or deformation. Additionally, when the thickness of the adhesive layer is uniform, performance of the entire film may be uniformly maintained so that cracks or deformation may be prevented during a forming process.

Meanwhile, an average delamination strength of the adhesive layer may be measured according to the following measurement method.

### [Measurement Method]

A secondary battery pouch film specimen having a machine-direction length of 150 mm and a transverse-direction length of 15 mm is prepared, and a sample is manufactured by removing remaining layers except for two layers to be subjected to measurement of delamination strength. A surface of the sample to be subjected to delamination is manually delaminated by about 3 cm, and after one surface of the sample is attached to a glass plate by using double-sided tape, an average delamination strength is measured at 25° C. and 120° C. by using a universal testing machine (UTM). In this case, an initial distance between an upper grip and a lower grip of the universal testing machine (UTM) is 30 mm, a pulling speed of the sample is 10 mm/min, and an average value of delamination strength measured while performing delamination by a total of 35 mm is defined as the average delamination strength.

According to the above measurement method, an average delamination strength of the adhesive layer laminated between the barrier layer and the second outer layer, measured at a speed of 50 mm/min by using a universal testing machine (UTM), may be 14 N/15 mm or more and 17 N/15 mm or less. More specifically, an average delamination strength of the adhesive layer laminated between the second outer layer and the barrier layer may be 14.0 N/15 mm or more, 14.2 N/15 mm or more, 14.4 N/15 mm or more, 14.6 N/15 mm or more, 14.8 N/15 mm or more, or 15.0 N/15 mm or more, and may be 17.0 N/15 mm or less, 16.8 N/15 mm or less, 16.6 N/15 mm or less, 16.4 N/15 mm or less, 16.2 N/15 mm or less, 16.0 N/15 mm or less, 15.8 N/15 mm or less, 15.6 N/15 mm or less, 15.4 N/15 mm or less, or 15.2 N/15 mm or less. When the average delamination strength of the adhesive layer laminated between the barrier layer and the second outer layer satisfies the above range, flexibility and durability of the secondary battery pouch film may be simultaneously ensured, so that a risk of breakage during a battery manufacturing process may be reduced, and internal corrosion may be prevented by allowing the adhesive layer to remain stable even in a high-temperature environment.

According to the above measurement method, an average delamination strength of the adhesive layer laminated between the first outer layer and the second outer layer, measured at a speed of 10 mm/min by using a universal testing machine (UTM), may be 5.3 N/15 mm or more and 5.5 N/15 mm or less. More specifically, an average delamination strength of the adhesive layer laminated between the first outer layer and the second outer layer may be 5.30 N/15 mm or more, 5.32 N/15 mm or more, 5.34 N/15 mm or more, 5.36 N/15 mm or more, 5.38 N/15 mm or more, or 5.40 N/15 mm or more, and may be 5.50 N/15 mm or less, 5.48 N/15 mm or less, 5.46 N/15 mm or less, 5.44 N/15 mm or less, or 5.42 N/15 mm or less. When the average delamination strength of the adhesive layer laminated between the first outer layer and the second outer layer satisfies the above range, an adhesive strength between the outer layers may be properly maintained to prevent separation and movement during processing, structural stability of the film may be ensured, and the film may withstand external impact or mechanical stress well, so that durability of the battery may be further improved.

Meanwhile, long-term reliability (a probability of delamination after forming) of the adhesive layer may be measured according to the following measurement method, and may satisfy Equation 1 below.

$$Number of delaminated samples / Number of total samples \leq 2 / 10 \qquad [ Equation 1 ]$$

### [Measurement Method]

Ten samples were manufactured by forming the pouch film into the same size by using a test mold (16 cm×9 cm) of Yulchon Chemical Co., Ltd. After the samples were manufactured, they were stored under conditions of 85° C./85 RH % for four weeks (28 days), and whether a delamination phenomenon occurred between the barrier layer and the second outer layer was visually identified. When lifting or delamination was observed, it was regarded as NG, and the number of deteriorated samples among the ten samples was recorded.

In Equation 1, the number of delaminated samples divided by the number of total samples may be 2/10 or less. When a probability of delamination of the adhesive layer after forming satisfies Equation 1, an interlayer adhesive strength of the secondary battery pouch film may be stably maintained even in a high-temperature and high-humidity atmosphere, and a lifespan characteristic and long-term reliability of the secondary battery may be significantly increased.

According to an embodiment of the present disclosure, an average thickness of the pouch film may be 150 μm or more and 250 μm or less. When a thickness of a highly formed or ultra-highly formed secondary battery pouch film becomes very large, an adhesive strength of the adhesive layer between the barrier layer and the second outer layer may decrease, and a delamination phenomenon may occur. When such a delamination phenomenon occurs, performance of the pouch film in terms of formability and safety may deteriorate rapidly. However, even when a thick secondary battery pouch film is highly formed, an adhesive strength of the adhesive layer may be maintained excellently for a long time by using the adhesive composition for a secondary battery pouch of the present disclosure. Accordingly, the adhesive composition for a secondary battery pouch of the present disclosure is particularly suitable for use in a thick secondary battery pouch film, and an average thickness of the secondary battery pouch film may be 150 μm or more and 250 μm or less. More specifically, an average thickness of the secondary battery pouch film may be 150 μm or more, 153 μm or more, 155 μm or more, 158 μm or more, 160 μm or more, 163 μm or more, 165 μm or more, 168 μm or more, 170 μm or more, 173 μm or more, 175 μm or more, 178 μm or more, or 180 μm or more, and may be 250 μm or less, 248 μm or less, 245 μm or less, 243 μm or less, 240 μm or less, 238 μm or less, 235 μm or less, 233 μm or less, 230 μm or less, 228 μm or less, 225 μm or less, 223 μm or less, 220 μm or less, 218 μm or less, 215 μm or less, 213 μm or less, or 210 μm or less.

According to an embodiment of the present disclosure, a ratio of thicknesses of the barrier layer and the adhesive layer may be 12 or more and 27 or less:1. By way of example, a ratio of thicknesses of the barrier layer and the adhesive layer may be 12 or more, 13 or more, 14 or more, 15 or more, 16 or more, 17 or more, 18 or more, 19 or more, or 20 or more, and may be 27 or less, 26 or less, 25 or less, 24 or less, 23 or less, 22 or less, or 21 or less. When the thickness ranges of the barrier layer and the adhesive layer are satisfied, durability of the secondary battery pouch film may be further improved as the adhesive layer maintains its interlayer adhesion strength while the barrier layer sufficiently serves to protect the adhesive layer from external gas, moisture, and heat, and flexibility and formability of the secondary battery pouch film may be optimized so that cracks or deformation may not occur during a forming process.

According to an embodiment of the present disclosure, the outer layer may be an outermost layer of the pouch film for an exterior of a lithium secondary battery, and may include a first outer layer and a second outer layer. The outer layer may have an appropriate thickness within a range in which sufficient mechanical strength and sufficient formability as an exterior material may be ensured. For example, a thickness of the outer layer may be 15 μm or more, 20 μm or more, 25 μm or more, 27 μm or more, or 35 μm or more, and may be 37 μm or less, 70 μm or less, 50 μm or less, or 40 μm or less. When the above range is satisfied, a dielectric breakdown voltage may be maintained at a high level. Specifically, the first outer layer mainly functions to provide protection against an external environment, and a material having strong durability may be used. This provides excellent chemical resistance, moisture resistance, and wear resistance, and serves to protect the film from external impact or chemical substances. The second outer layer serves to supplement an internal performance and increase an adhesion force with the barrier layer, and a material having a high mechanical strength and a good flexibility may be used. Through this, it increases a formability of the secondary battery pouch film, and allows the secondary battery pouch film to maintain a desired shape without cracks or deformation during a forming process.

The first outer layer may include one or more materials selected from the group consisting of polyethylene, polypropylene, polycarbonate, polyethylene terephthalate, polybutylene terephthalate, polytrimethylene terephthalate, polyethylene acrylic polymer, naphthalate, polyvinyl chloride, polyacrylonitrile, polyimide, polyamide, cellulose, aramid, nylon, polyester, poly-p-phenylene benzobisoxazole, polyarylate, Teflon, and glass fiber.

Furthermore, the second outer layer that is a heat-resistant resin layer having a melting point higher than a heat-sealing temperature of the sealant layer may include one or more compounds selected from the group consisting of polyamide-based compounds, polyester-based compounds, polyolefin-based compounds, and polyacrylic-based compounds.

According to an embodiment of the present disclosure, the outer layer may be formed as a laminate film of a first outer layer (polyethylene terephthalate) and a second outer layer (nylon), and in this case, a formability becomes advantageous as a thickness of the first outer layer becomes smaller and a thickness of the second outer layer becomes larger. However, as a thickness of the first outer layer becomes smaller, it may be disadvantageous in terms of a dielectric breakdown voltage. From this viewpoint, a thickness of the first outer layer may be 20 μm or more and 40 μm or less, and, by way of example, a thickness of the first outer layer may be 20 μm or more, 21 μm or more, 23 μm or more, 25 μm or more, 27 μm or more, or 29 μm or more, and may be 40 μm or less, 39 μm or less, 37 μm or less, 35 μm or less, 33 μm or less, 31 μm or less, or 30 μm or less. When the first outer layer satisfies the above thickness range, it is possible to effectively prevent an appearance contamination by the coating layer described above, and at the same time maintain an excellent level of forming.

Furthermore, a thickness of the second outer layer may be 10 μm or more, 12 μm or more, 15 μm or more, 17 μm or more, or 20 μm or more, and may be 40 μm or less, 37 μm or less, 35 μm or less, 30 μm or less, 27 μm or less, or 25 μm or less. The second outer layer may include two or more nylon-based resins that are the same or different from each other. Because it is difficult to increase a thickness of nylon that may be included in the second outer layer of the outer layer to 30 μm or more due to a manufacturing method, the second outer layer may be manufactured by using two or more nylon sheets.

According to an embodiment of the present disclosure, the first outer layer may further include a pouch film that further includes one or more polymers selected from the group consisting of polyester-based polymers and polyolefin-based polymers.

Here, the polyolefin-based polymer may include one or more materials selected from the group consisting of an ethylene-propylene copolymer (EPR), an ethylene-butene copolymer (EBR), an ethylene-hexene copolymer (EHR), an ethylene-octene copolymer (EOR), a propylene-butene copolymer (PBR), a propylene-hexene copolymer (PHR), a propylene-octene copolymer (POR), an LLDPE resin, a thermoplastic polyurethane (TPU) resin, and an ethylene vinyl acetate (EVA) resin. Furthermore, the polyester-based polymer may include one or more materials selected from the group consisting of isophthalic acid (IPA), naphthalene dicarboxylic acid, and cyclohexanedimethanol (CHDM).

Because the first outer layer of the present disclosure includes a polyester-based polymer, it is possible to secure a durability and a thermal stability of the film, and increase an elongation to prevent crack and breakage phenomena that may occur during film forming. Furthermore, the first outer layer may have an excellent flexibility and a low elastic modulus by the polyolefin-based polymer so that a high formability can be implemented, and may have a high thermal stability and minimize a thermal shrinkage. Furthermore, it is preferable that the isophthalic acid be included because it improves a formability of the film by lowering a crystallinity of a film resin composition, and is efficient in terms of costs.

According to an embodiment of the present disclosure, the polyester-based polymer and the polyolefin-based polymer may each be included in an amount of 5 wt % or more and 15 wt % based on an entire resin of the first outer layer. By way of example, a content of the polyester-based polymer and the polyolefin-based polymer may be 5.0 wt % or more, 6.0 wt % or more, 7.0 wt % or more, 8.0 wt % or more, 9.0 wt % or more, or 10.0 wt % or more, and may be 15.0 wt % or less, 14.0 wt % or less, 13.0 wt % or less, 12.0 wt % or less, or 11.0 wt % or less based on an entire resin of the first outer layer. When the polyester-based polymer and the polyolefin-based polymer are each included in the first outer layer in the contents within the above range, a formability may be improved, a heat resistance and a thermal-shrinkage stability may be increased, a mechanical strength and a chemical durability may be improved, and a durability against contact with an electrolyte and chemical substances may be enhanced so that a film degradation may be prevented and a battery lifetime may be increased, and an excellent interfacial adhesive strength may be ensured.

Furthermore, according to an embodiment of the present disclosure, a thickness of the barrier layer may be 70 μm or more and 100 μm or less. The barrier layer may maintain a chemical stability of an electrolyte and an electrode by preventing gases, such as oxygen and carbon dioxide and external moisture, from penetrating into the battery. Furthermore, it may ensure a stability by preventing chemical substances in an interior of the battery from leaking to the outside, and may prevent a structural damage by protecting the interior of the battery from external impacts or pressure. In addition, it may prevent degradation of performance due to a temperature change by blocking an external heat from being transferred to an interior of the battery.

The barrier layer may be an intermediate layer (e.g., a layer that is disposed between the outer layer and the sealant layer) of the pouch film for the exterior of the lithium secondary battery, and although a type of the barrier layer is not particularly limited, it may include at least one selected from the group consisting of aluminum, stainless steel, copper, titanium, and alloys thereof, and may specifically include aluminum.

The barrier layer may have an appropriate thickness within a range, in which a sufficient formability may be secured while effectively blocking penetration of the gas and/or moisture described above. By way of example, a thickness of the barrier layer may be 70 μm or more, 72 μm or more, 74 μm or more, or 75 μm or more, and may be 100 μm or less, 99 μm or less, 98 μm or less, 96 μm or less, 94 μm or less, 92 μm or less, 90 μm or less, 88 μm or less, 86 μm or less, 84 μm or less, 82 μm or less, 80 μm or less, 78 μm or less, or 76 μm or less.

According to an embodiment of the present disclosure, the sealant layer may be an innermost layer of the pouch film for the exterior of the lithium secondary battery. That is, the sealant layer may directly contact a battery body part (e.g., an electrode, a separator, and/or an electrolyte). Therefore, the sealant layer has to have an excellent electrolyte resistance and an excellent insulation. To this end, the sealant layer may include at least a polyolefin-based resin. The polyolefin-based resin has an excellent electrolyte resistance and an excellent insulation, and accordingly, the sealant layer that includes the polyolefin-based resin may also have an excellent electrolyte resistance and an excellent insulation derived from the polyolefin-based resin.

The polyolefin-based resin may include, for example, a polyolefin derived from an olefin or a derivative thereof, a copolymer thereof, or a blend that includes at least one thereof. For example, the polyolefin-based resin may include one or more selected from the group consisting of polyethylene, polypropylene, polybutylene, a copolymer derived from monomers derived from ethylene and/or propylene and monomers derived from an α-olefin, and a blend thereof.

By way of example, a thickness of the sealant layer may be 20 μm or more, 30 μm or more, 40 μm or more, or 50 μm or more, and may be 100 μm or less, 90 μm or less, 80 μm or less, 70 μm or less, or 60 μm or less, and when the above numerical range is satisfied, an excellent electrolyte resistance and an excellent insulation may be obtained.

According to an embodiment of the present disclosure, the sealant layer may be configured as a laminate of two or more layers in terms of diversifying functions. As a specific example, the sealant layer may include a first sealant layer that is disposed on the barrier layer, and a second sealant layer that is disposed on the first sealant layer. Here, the first sealant layer may be a layer that serves to assist an adhesion between the barrier layer and the second sealant layer and further improves a function as the sealant layer as well, and the second sealant layer may be a layer that constitutes an innermost sealant layer of the pouch film and serves to prevent a leakage of the secondary battery, particularly, the non-aqueous electrolyte. The first sealant layer may be an extrusion lamination coating (EC) layer (mainly an extruded polypropylene layer), and the second sealant layer may be a polypropylene (PP) layer resin, preferably a cast polypropylene (CPP) layer under the first sealant layer (on an inner side of the pouch film). In this case, by way of example, a thickness of the cast polypropylene (CPP) layer of the sealant layer may be 20 μm or more, 30 μm or more, 40 μm or more, or 50 μm or more, and may be 80 μm or less, 70 μm or less, or 60 μm or less, and a thickness of the polypropylene (PP) layer of the sealant layer may be 0 μm or more, 10 μm or more, 20 μm or more, or 30 μm or more, and may be 60 μm or less, 50 μm or less, or 40 μm or less.

Furthermore, according to an embodiment of the present disclosure, the polypropylene (PP) layer of the sealant layer may contain various additives (rubber, elastomers, slip agents, etc.) depending on required properties.

Hereinafter, the present disclosure will be described in more detail with reference to embodiments. However, the following embodiments are provided only for illustrating the present disclosure, and the scope of the present disclosure is not limited thereto.

### EMBODIMENTS

### Embodiment 1

To laminate the second outer layer (nylon layer) on one surface of a 60-μm-thick aluminum foil serving as the barrier layer, after a 3.5-μm-thick adhesive layer was applied by a gravure-roll method, a 25-μm-thick nylon film was dry-laminated and laminated onto the aluminum foil. To laminate the first outer layer (PET layer) thereon, after a 3.5-μm-thick adhesive layer was applied by a gravure-roll method, a 12-μm-thick polyester film was dry-laminated and laminated thereon. To laminate the sealant layer, a film for a cell pouch was manufactured by thermally melt-adhering and laminating polypropylene with a thickness of 80 μm onto the aluminum by using an extrusion-lamination method. After a coating liquid was applied to the surface-treatment layer (adhesive layer), a pouch film was manufactured by improving an adhesion strength of the layer formed through a heat treatment at a temperature of 60° C. to 90° C. for seconds to 40 seconds. Here, an adhesive composition included in the adhesive layer was prepared by the following method.

For the preparation of the adhesive composition, a mixture solution was prepared by introducing 100 parts by weight of polyester polyol as a main agent, 7.64 parts by weight of isophorone diisocyanate as a curing agent, and 65.45 parts by weight of ethyl acetate as a solvent into a four-neck flask, and stirring the contents so that they would not be discharged to the outside of the four-neck flask, and the mixture was stirred at 25° C. for 30 minutes at a speed of 30 rpm. Thereafter, 0.73 parts by weight of 2,2′-dimorpholinodiethyl ether as a reaction retarder and 0.36 parts by weight of polycaprolactone as a plasticizer were introduced into the mixture solution, and the mixture was reacted at 25° C. for 30 minutes to complete an adhesive composition for a secondary-battery pouch.

### Embodiments 2 to 4

An adhesive composition and a pouch film including the adhesive composition were manufactured in the same manner as in Embodiment 1, except for varying contents of the plasticizer and the reaction retarder of the adhesive composition as in Table 1.

### Embodiments 5 to 8

An adhesive composition and a pouch film including the adhesive composition were manufactured in the same manner as in Embodiment 1, except for varying contents of the curing agent, the plasticizer, and the reaction retarder of the adhesive composition as in Table 2.

### Comparative Examples 1 to 12

An adhesive composition and a pouch film including the adhesive composition were manufactured in the same manner as in Embodiment 1, except for varying contents of the curing agent, the plasticizer, and the reaction retarder of the adhesive composition as in Tables 1 and 2.

### EXPERIMENTAL EXAMPLES

### Experimental Example 1: Measurement of Bubble Generation Rate

After pouch films of the above embodiment and comparative example were cut into a size of 15 mm×15 mm, an interface between the barrier layer and the sealant layer was photographed by using an optical microscope (DM2700 manufactured by Leica, P Lens ×150, measurement area of 1.637 mm², and a white-LED lamp as a light source). A magnification of the photographed image was input, and an area of bubbles that are visible at the interface between the barrier layer and the sealant layer was measured. The bubble generation rate was calculated as “(bubble area/total measurement area)×100(%)”.

### Embodiment 2: Probability of Delamination after Forming (Long-Term Reliability)

By using the adhesive composition manufactured in the above embodiment and comparative example, an adhesive layer having a thickness of 3.5 μm was disposed between the second outer layer and the barrier layer of the secondary-battery pouch film, in which an inner sealant layer, a barrier layer of an aluminum substrate, a second outer layer of a nylon substrate, and a first outer layer of a polyethylene terephthalate substrate were sequentially laminated. Thereafter, a specimen of the secondary-battery pouch film, in which the adhesive layer was disposed, was formed by using a test mold (16 cm×9 cm) of Youlchon Chemical Co., Ltd. to manufacture ten samples, and after these samples were left for four weeks under conditions of 85° C. and 85% relative humidity, a probability of delamination after forming was measured by identifying the number of delaminated samples with respect to a total number of samples. When lifting or delamination was observed, it was regarded as NG, and the number of deteriorated samples among the ten samples was recorded.

### Experiment 3: Measurement of Average Delamination Strength

Specimens were prepared by cutting pouch films of the embodiment and the comparative example to a length of 150 mm in a machine direction and a length of 15 mm in a transverse direction, and samples were manufactured by removing remaining layers, except for two layers to be subjected to measurement of delamination strength. A surface of the sample to be subjected to delamination was manually delaminated by about 3 cm, and after one surface of the sample was attached to a glass plate by using double-sided tape, an average delamination strength was measured at 25° C. and 120° C. by using a universal testing machine (UTM). In this case, an initial distance between an upper grip and a lower grip of the universal testing machine (UTM) was 30 mm, a pulling speed of the sample was 10 mm/min, and an average value of delamination strength measured while performing delamination by a total of 35 mm was defined as the average delamination strength.

### Experiment 4: Coating Uniformity

Weight of the pouch film of the embodiment and the comparative example including the adhesive layer and weights of the pouch films after the adhesive layer was delaminated were measured, and coating weights of the adhesive layers were measured from a difference therebetween, and coating uniformity was calculated by computing a standard deviation of the weights of the adhesive layers. The experiment was performed ten times. The coating uniformity is more preferable as the value becomes lower.

### Experiment 5: Tensile Strength

According to ASTM D882, specimens of the pouch films of the embodiment and the comparative example having a width of 15 mm and a length of 150 mm were prepared, and after the specimens were fixed between two jigs of a tensile tester (UTM) having an initial jig gap of 50 mm at room temperature, a maximum peak (strength (N)) measured while pulling the specimens in an MD direction at a measurement speed of 10 mm/min until breakage was derived as the tensile strength.

TABLE 1

| | | | | | Long- | | | | |
|---|---|---|---|---|---|---|---|---|---|
| | Curing | | Reaction | | term | Delamination | delamination | | Tensile |
| | Agent | Plasticizer | Retarder | Bubble | reliability | Strength | strength | Coating | Strength |
| | (Parts | (Parts | (Parts | Generation | NG/Number | (120° C.) | (25° C.) | Uniformity | MD |
| | by | by | by | Rate | of | (N/15 | (N/15 | (Surface | (N/15 |
| Classification | weight) | Weight) | Weight) | (%) | Samples | mm) | mm) | Deviation) | mm) |
| Embodiment 1 | 7.64 | 0.36 | 0.73 | 0.9 | 1/10 | 6.7 | 15.02 | 0.28 | 214 |
| Embodiment 2 | 7.64 | 0.91 | 0.73 | 0.7 | 1/10 | 7.1 | 15.42 | 0.18 | 219 |
| Embodiment 3 | 7.64 | 0.36 | 1.45 | 0.14 | 1/10 | 6.5 | 15.15 | 0.3 | 215 |
| Embodiment 4 | 7.64 | 0.91 | 1.45 | 0.13 | 0/10 | 7.3 | 15.46 | 0.11 | 223 |
| Comparative | 7.64 | — | — | 3.2 | 2/10 | 6.5 | 14.56 | 0.92 | 210 |
| Example 1 | | | | | | | | | |
| Comparative | 7.64 | 1.45 | 2.55 | 0.5 | 3/10 | 5.9 | 13.86 | 0.25 | 207 |
| Example 2 | | | | | | | | | |
| Comparative | 7.64 | 1.45 | 1.45 | 0.2 | 2/10 | 5.2 | 14.09 | 0.36 | 202 |
| Example 3 | | | | | | | | | |
| Comparative | 7.64 | 0.36 | 2.18 | 0.11 | 5/10 | 6.0 | 14.46 | 0.41 | 201 |
| Example 4 | | | | | | | | | |
| Comparative | 7.64 | 0.91 | 2.18 | 0.15 | 6/10 | 6.4 | 14.23 | 0.2 | 198 |
| Example 5 | | | | | | | | | |
| Comparative | 7.64 | 1.45 | 2.18 | 0.14 | 6/10 | 4.8 | 13.28 | 0.32 | 192 |
| Example 6 | | | | | | | | | |

* Main Agent: Polyester Polyol
* Curing Agent: Isophorone Diisocyanate (HDI)
* Solvent: Ethyl Acetate
* Plasticizer: Polycaprolactone (PCL)
* Reaction Retarder: 2,2′-Dimorpholinodiethyl Ether (DMDEE)

TABLE 2

| | | | | | Long- | | | | |
|---|---|---|---|---|---|---|---|---|---|
| | Curing | | Reaction | | term | Delamination | delamination | | Tensile |
| | Agent | Plasticizer | Retarder | Bubble | reliability | Strength | strength | Coating | Strength |
| | (Parts | (Parts | (Parts | Generation | NG/Number | (120° C.) | (25° C.) | Uniformity | MD |
| | by | by | by | Rate | of | (N/15 | (N/15 | (Surface | (N/15 |
| Classification | Weight) | Weight) | Weight) | (%) | Samples | mm) | mm) | Deviation) | mm) |
| Embodiment 5 | 12.73 | 0.36 | 0.73 | 1.5 | 2/10 | 6.9 | 14.82 | 0.35 | 215 |
| Embodiment 6 | 12.73 | 0.91 | 0.73 | 1.8 | 1/10 | 7.2 | 15.17 | 0.18 | 220 |
| Embodiment 7 | 12.73 | 0.36 | 1.45 | 0.18 | 1/10 | 7.4 | 14.92 | 0.42 | 216 |
| Embodiment 8 | 12.73 | 0.91 | 1.45 | 0.15 | 0/10 | 7.8 | 15.25 | 0.15 | 218 |
| Comparative | 12.73 | — | — | 4.2 | 3/10 | 6.7 | 14.13 | 1.05 | 212 |
| Example 7 | | | | | | | | | |
| Comparative | 12.73 | 1.45 | 2.55 | 2.5 | 5/10 | 7.1 | 13.75 | 0.36 | 213 |
| Example 8 | | | | | | | | | |
| Comparative | 12.73 | 1.45 | 1.45 | 0.16 | 2/10 | 6.0 | 13.86 | 0.25 | 215 |
| Example 9 | | | | | | | | | |
| Comparative | 12.73 | 0.36 | 2.18 | 0.8 | 4/10 | 5.0 | 14.1 | 0.39 | 202 |
| Example 10 | | | | | | | | | |
| Comparative | 12.73 | 0.91 | 2.18 | 0.7 | 5/10 | 5.6 | 14.02 | 0.22 | 195 |
| Example 11 | | | | | | | | | |
| Comparative | 12.73 | 1.45 | 2.18 | 0.6 | 5/10 | 5.2 | 13.32 | 0.48 | 198 |
| Example 12 | | | | | | | | | |

* Main Agent: Polyester Polyol
* Curing Agent: Isophorone Diisocyanate (HDI)
* Solvent: Ethyl Acetate
* Plasticizer: Polycaprolactone (PCL)
* Reaction Retarder: 2,2′-Dimorpholinodiethyl Ether (DMDEE)

Referring to Tables 1 and 2, in Embodiments 1 to 8, in which an adhesive composition having contents of the plasticizer and the reaction retarder that satisfy content ranges of the present disclosure was used, it may be identified that the bubble generation rate, the long-term reliability, the delamination strength at room temperature and at a high temperature, the coating uniformity, and the tensile strength correspond to levels that are all excellently balanced.

In contrast, in Comparative Examples 1 and 7, in which the plasticizer and the reaction retarder were not included, it that the bubble generation was may be identified significantly increased and that characteristics, such as the coating uniformity, corresponded to inferior levels. Furthermore, in Comparative Examples 2, 3, 8, and 9, in which the content of the plasticizer deviated from ranges of the present disclosure, it may be identified that the delamination strength at room temperature and at a high temperature was low and that the long-term reliability was also poor. Furthermore, in Comparative Examples 4 to 6 and 10 to 12, in which the content of the reaction retarder deviated from ranges of the present disclosure, it may be identified that the long-term reliability was remarkably inferior and that mechanical properties, such as the delamination strength and the tensile strength, were also degraded.

According to the present disclosure, by adjusting contents of components included in the adhesive composition, a bubble generation rate on a surface of the barrier layer may be reduced, and a delamination strength at room temperature and at a high temperature and an impact resistance of an adhesive layer of a secondary-battery pouch film including the adhesive composition may be improved.

In addition, in the pouch film of the present disclosure, even under high-temperature and high-humidity conditions, delamination after forming may be significantly reduced, so that long-term reliability may be increased.

In addition, in the pouch film of the present disclosure, a coating uniformity may be improved, and mechanical properties, such as a tensile strength, may be at excellent levels.

### Acknowledgement

Project Identification Number: 2410004468
Project Number: 20022450
Ministry: Ministry of Trade, Industry and Energy (MOTIE)
Project Management (Specialized) Agency: Korea Institute for Advancement of Technology (KIAT)
Program Name: Materials and Components Technology
Development (Top-tier Enterprise Program)
Project Title: Development of Next-Generation Secondary Battery Pouch with More Than Double Adhesion Strength at 60° C.
Contribution Ratio: 1/1
Participating Organization: Youlchon Chemical Co., Ltd.
Project Duration: Jan. 1, 2024-Dec. 31, 2024

### Acknowledgement 2

Project Identification Number: 2410013070
Project Number: 20022450
Ministry: Ministry of Trade, Industry and Energy
Project Management (Specialized) Agency: Korea Institute for Advancement of Technology (KIAT)
Program Name: Component & Material Technology Development (First-Class Enterprise Program)
Project Title: Development of Next-Generation Battery Pouch Capable of Achieving More Than Twofold Adhesion Strength at 60° C.
Contribution Ratio: 1/1
Participating Organization: Yulchon Chemical Co., Ltd.
Project Duration: Jan. 1, 2025-Dec. 31, 2025

What is claimed is:

1. A pouch film comprising:
an outer layer; an adhesive layer; a barrier layer; and a sealant layer,
wherein the adhesive layer includes an adhesive composition including a main agent, a curing agent, a plasticizer, and a reaction retarder, and
wherein, based on 100 parts by weight of the main agent, the plasticizer is included in an amount of 0.1 parts by weight or more and 1.4 parts by weight or less, and the reaction retarder is included in an amount of 0.1 parts by weight or more and 2.0 parts by weight or less.

2. The pouch film of claim 1, wherein, based on 100 parts by weight of the main agent, the curing agent is included in an amount of 5 parts by weight or more and 15 parts by weight or less, and a solvent is included in an amount of 50 parts by weight or more and 80 parts by weight or less.

3. The pouch film of claim 1, wherein, based on 100 parts by weight of the main agent, the plasticizer is included in an amount of 0.3 parts by weight or more and 1.0 parts by weight or less, and the reaction retarder is included in an amount of 0.7 parts by weight or more and 1.5 parts by weight or less.

4. The pouch film of claim 1, wherein the main agent includes a polyester polyol, and
wherein the polyester polyol includes one or more compounds selected from the group consisting of a polyester polyol of 1,4-butanediol and adipic acid, a polycarbonate diol, and a polyurethane polyol.

5. The pouch film of claim 1, wherein the curing agent includes one or more compounds selected from the group consisting of aliphatic isocyanate and aromatic isocyanate.

6. The pouch film of claim 5, wherein the curing agent includes one or more compounds selected from the group consisting of hexamethylene diisocyanate, isophorone diisocyanate, methylene diphenyl diisocyanate, toluene diisocyanate, and xylene diisocyanate.

7. The pouch film of claim 1, wherein the plasticizer includes one or more compounds selected from the group consisting of polycaprolactone, dioctyl phthalate, dioctyl adipate, acetyl tributyl citrate, and polycarbonate diol.

8. The pouch film of claim 1, wherein the reaction retarder includes one or more compounds selected from the group consisting of phenyl carbamate, butyl carbamate, 2,2′-dimorpholinodiethyl ether, triethylenediamine, triphenyl phosphite, and tris(2-chloroethyl) phosphite.

9. The pouch film of claim 1, wherein the outer layer includes a first outer layer and a second outer layer laminated between the first outer layer and the barrier layer, and
wherein the adhesive layer is disposed at one or more positions selected from the group consisting of between the second outer layer and the barrier layer and between the first outer layer and the second outer layer.

10. The pouch film of claim 1, wherein an average thickness of the adhesive layer is 3 μm or more and 5 μm or less.

11. The pouch film of claim 1, wherein an average thickness of the pouch film is 150 μm or more and 250 μm or less.

12. The pouch film of claim 9, wherein the first outer layer includes one or more materials selected from the group consisting of polyethylene, polypropylene, polycarbonate, polyethylene terephthalate, polybutylene terephthalate, polytrimethylene terephthalate, polyethylene naphthalate, polyvinyl chloride, acrylic polymer, polyacrylonitrile, polyimide, polyamide, cellulose, aramid, nylon, polyester, poly-p-phenylene benzobisoxazole, polyarylate, Teflon, and glass fiber.

13. The pouch film of claim 9, wherein the second outer layer includes one or more compounds selected from the group consisting of polyamide-based compound, polyester-based compound, polyolefin-based compound, and polyacrylic-based compound.

14. The pouch film of claim 1, wherein a ratio of a thickness of the barrier layer to a thickness of the adhesive layer is 12 to 27:1.

15. An adhesive composition comprising:
a polyester polyol,
wherein, based on 100 parts by weight of the polyester polyol, the composition includes 5 to 15 parts by weight of a curing agent, 0.1 to 1.4 parts by weight of a plasticizer, and 0.1 to 2.0 parts by weight of a reaction retarder.
